(19) United States
(12) Patent Application Publication
(10) Pub. No.: US 2025/0224946 A1
(43) Pub. Date: Jul. 10, 2025

(54) SYSTEM AND METHOD FOR DETERMINING MODULE INTERDEPENDENCY USING ADVANCED COMPUTATIONAL MODELS FOR DATA ANALYSIS AND AUTOMATED PROCESSING

(71) Applicant: BANK OF AMERICA CORPORATION, Charlotte, NC (US)

(72) Inventors: Malinda Kieffer, Chillicothe, MO (US); Tanya A. Wilson, Newark, DE (US); Susan J. Moss, Vestal, NY (US); Andrzej Grabski, Glen Rock, NJ (US); Kiran Boosetty, Jacksonville, FL (US); Donna Lee Phillips, Elkton, MD (US); Robert Ronald Rosseland, JR., Huntersville, NC (US); Ravinder Kaur Sodhi, Royse City, TX (US); Rahul Kumar Mishra, Skillman, NJ (US); Samuel M. Moiyallah, JR., Newark, DE (US); Gerard P. Gay, Seattle, WA (US)

(73) Assignee: BANK OF AMERICA CORPORATION, Charlotte, NC (US)

(21) Appl. No.: 18/404,265

(22) Filed: Jan. 4, 2024

(51) Int. Cl. G06F 8/65

(52) U.S. Cl. CPC G06F 8/65

(57) ABSTRACT

Systems, computer program products, and methods are described herein for determining module interdependency using advanced computational models for data analysis and automated processing. The present disclosure is configured to receive a module characteristic from a system environment, wherein the system environment comprises a module; map the module characteristic, wherein mapping the module characteristic comprises comparing the module characteristic associated with the module with the module characteristic associated with the system environment; determine a weight for the module, wherein determining the weight comprises evaluating a significance level of the information produced by the module, analyzing a number of active modules contributing to a process, computing a weight value, and prioritizing the modules based on the weight value; determine, using an artificial intelligence module, a module update for the module characteristic, wherein the module update comprises updating the module characteristic; and implement the module update in the system environment.

### TECHNOLOGICAL FIELD

Example embodiments of the present disclosure relate to determining module interdependency using advanced computational models for data analysis and automated processing.

### BACKGROUND

There are significant challenges associated with determining dependency between modules in a computer system environment. Applicant has identified a number of deficiencies and problems associated with determining module interdependency using advanced computational models for data analysis and automated processing. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for determining module interdependency using advanced computational models for data analysis and automated processing.

Embodiments of the present invention address the above needs and/or achieve other advantages by providing apparatuses (e.g., a system, computer program product, and/or other devices) and methods for determining module interdependency using advanced computational models for data analysis and automated processing. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present invention may receive a module characteristic from a system environment, wherein the system environment comprises one or more modules, and wherein the module characteristic comprises module dependencies, module certifications, and module versions. In some embodiments, the present invention may map the module characteristic, wherein mapping the module characteristic comprises comparing the module characteristic associated with the module with the module characteristic associated with the system environment. In some embodiments, the present invention may determine a weight for the one or more modules, wherein determining the weight comprises evaluating a significance level of the information produced by the modules, analyzing a number of active modules contributing to a process, computing a weight value, and prioritizing the modules based on the weight value. In some embodiments, the present invention may determine, using an artificial intelligence module, a module update for the module characteristic, wherein the module update comprises updating the module dependencies, module certifications, and module versions. In some embodiments, the present invention may implement the module update in the system environment.

In some embodiments, receiving the module characteristic comprises receiving the module characteristic associated with the one or more modules of the system environment.

In some embodiments, mapping the module characteristic comprises analyzing the dependencies between the module and the additional modules in the system environment. In some embodiments, mapping the module characteristic comprises creating a module map, wherein the module map comprises mapping interdependencies of the one or more modules within the system environment.

In some embodiments, the present invention may determine, in response to the module map, a redundant module dependency, wherein the redundant module dependency comprises the module receiving the module characteristic from more than one additional module. In some embodiments, the present invention may configure, in response to determining a redundant module dependency, the module to receive the module characteristic from one module.

In some embodiments, determining the module update further comprises receiving, from the module, the module characteristics associated with the module. In some embodiments, determining the module update further comprises receiving, from the system environment, the module characteristics associated with the module. In some embodiments, determining the module update further comprises determining a mismatch of the module characteristics received from the module and the module characteristics received from the system environment. In some embodiments, determining the module update further comprises determining the module update in response to the mismatch between the module characteristics received from the module and the module characteristics received from the system environment.

In some embodiments, implementing the module update in the system environment comprises the artificial intelligence module implementing the module update.

In some embodiments, the present invention may create a module dependency interface, wherein the module dependency interface comprises the module characteristics associated with the module and the dependency module map. In some embodiments, the present invention may transmit the module dependency interface to a user device, wherein transmitting the module dependency interface configures a graphical user interface of the user device.

In some embodiments, the module characteristic further comprises information relating to how the module interacts with the one or more additional modules and the system environment.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for determining module interdependency using advanced computational models for data analysis and automated processing, in accordance with an embodiment of the disclosure;

FIG. 2 illustrates a process flow for determining module interdependency using advanced computational models for data analysis and automated processing, in accordance with an embodiment of the disclosure.

FIG. 3 illustrates a process flow for configuring a module to receive a module characteristic from one module, in accordance with an embodiment of the disclosure.

FIG. 4 illustrates a process flow for determining a module update in response to a mismatch between the module characteristics received from the module and the module characteristics received from a system environment, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

Module interdependency (e.g., dependency) is a foundation in architecture of computing system environments today. A specific module may specialize in performing certain processes in an efficient manner, and may be implemented into a system to further increase performance of the system as a whole. Further, when more than one module is introduced to a system, the modules may become dependent on one another to perform the required process. Crucially, updating these modules within the system is required from time to time as technology is updated, software is reconfigured, applications receive new versions, module certifications are renewed, and/or the like. For a system to perform as expected, the any module updates must be disseminated across the system and other modules associated with the system.

Conventional computer-based environment systems do not have the capability to manage documentation associated with the environment in an accurate and effective manner. When systems (e.g., computer-based systems) require updating, servicing, maintenance, and/or the like, conventional management practices often miss documenting the update, service, or management. Additionally, sub-systems of the computer environment may be dependencies on other systems, sub-systems, applications, and/or the like. If a system is updated, conventional management practices may not capture the dependency, which leads to upstream systems or downstream systems experiencing an outage. Further, there is difficulty in assessing change impacts without properly understanding the software or hardware dependency between different systems, sub-systems, applications, components, or the like.

The present invention discloses a system that is made up of one or more modules (e.g., applications, software, hardware, components, and/or the like). The modules may be dependent on other modules to perform certain actions. From time to time, a module may be updated to a newer version, to receive a new certification, or to capture new module dependencies. In this way, the system may use an artificial intelligence model to determine where the dependencies lie, and which modules should be updated. For instance, if a first module is dependent on a second module and the second module has a renewed certification, the artificial intelligence model may also update the first module to use the second module's renewed certification. In some embodiments, the artificial intelligence model may also analyze the system for redundant module dependencies. In this way, the artificial intelligence model may learn which modules are receiving the same information from more than one module and re- route the flow of information to be more efficient.

What is more, the present disclosure provides a technical solution to a technical problem. As described herein, the technical problem includes accurately and effectively documenting dependencies, certifications, versions, updates, and/or the like of modules during system maintenance and/or updates. The technical solution presented herein allows for determining module interdependency within a system environment. In particular, the module interdependency determination system is an improvement over existing solutions to the issue of properly documenting complicated system, sub-system, application, component, and/or the like dependencies, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer platform itself. Specifically, the module interdependency determination system as described herein is a solution to the problem of accurately and effectively documenting dependencies, certifications, versions, updates, and/or the like of modules during system maintenance and/or updates. Further, the module interdependency determination system may be characterized as identifying a specific improvement in computer capabilities and/or network functionalities in response to the module interdependency determination system's integration to existing devices, software, applications, and/or the like. In this way, the module interdependency determination system improves the capability of a system to determine module interdependency within a system environment. Further, the module interdependency determination system improves the functionality of networks in response to reducing the resources consumed by the system (e.g., network resources, computing resources, memory resources, and/or the like).

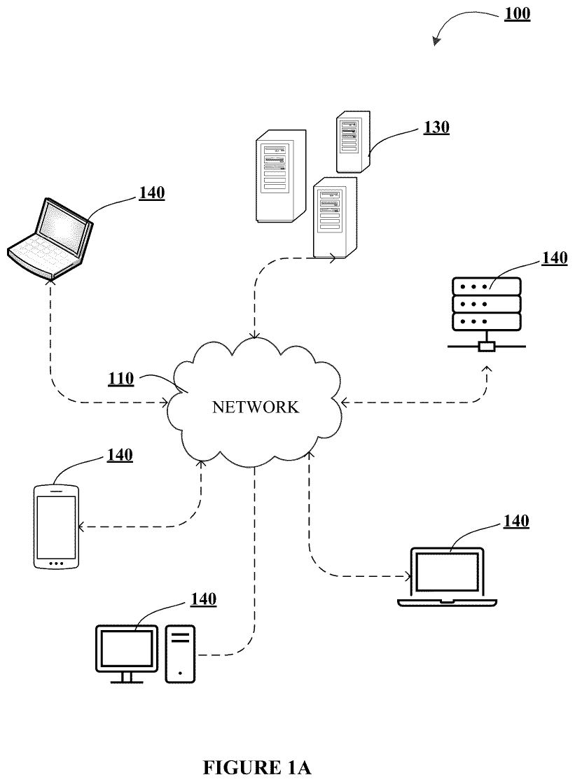

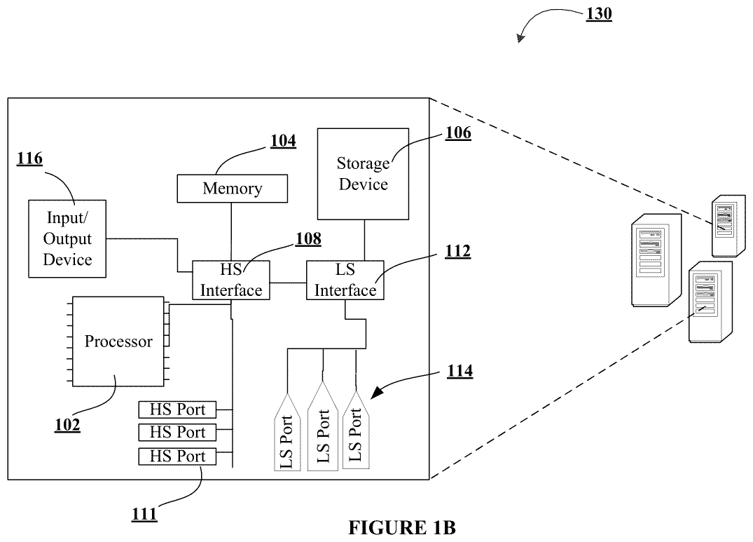

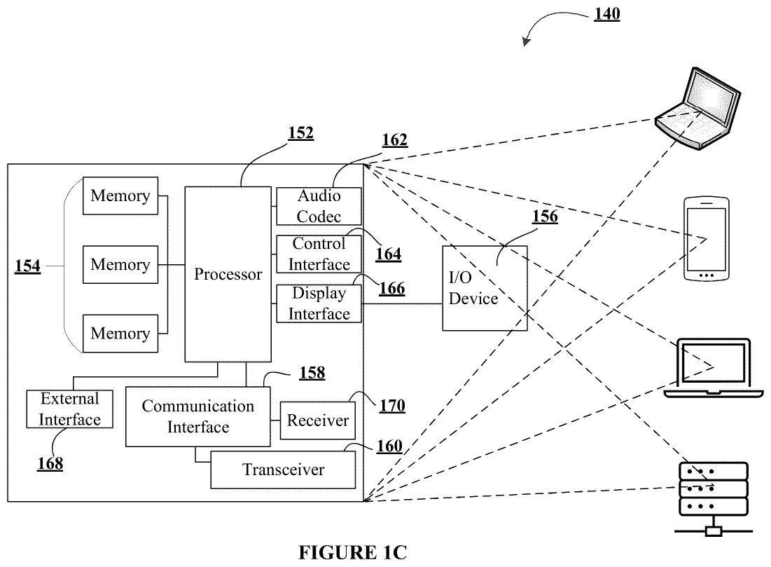

FIGS. 1A-1C illustrate technical components of an exemplary distributed computing environment 100 for determining module interdependency using advanced computational models for data analysis and automated processing, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

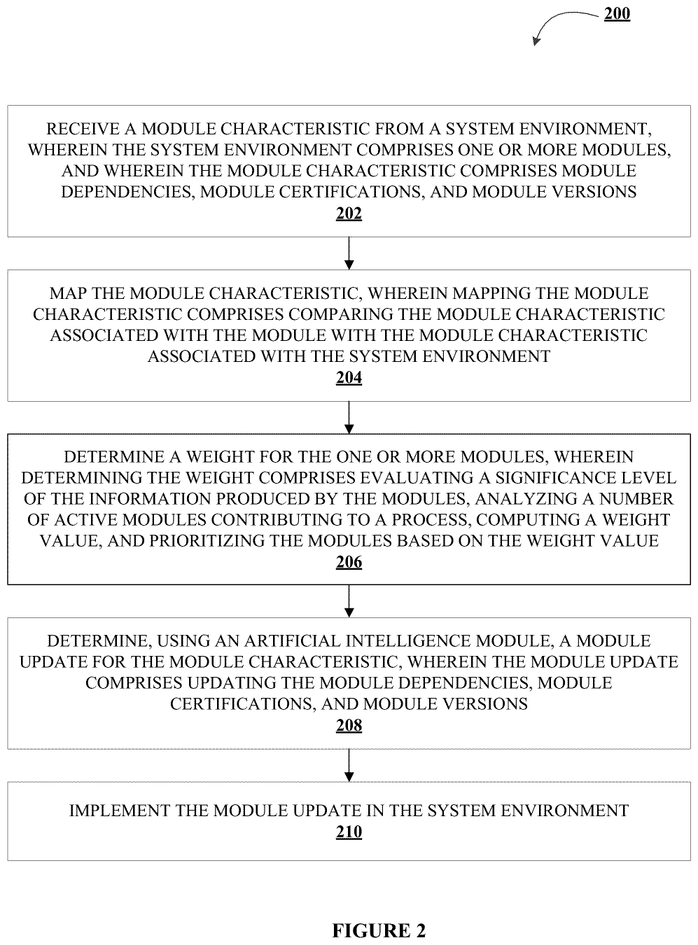

FIG. 2 illustrates a process flow for determining module interdependency using advanced computational models for data analysis and automated processing, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a module interdependency determination system (e.g., similar to one or more of the systems described herein with respect to FIGS. 1A-1C) may perform one or more of the steps of process flow 200. For example, a module interdependency determination system (e.g., the system 130 described herein with respect to FIGS. 1A-1C) may perform the steps of process flow 200.

As shown in block 202, the process flow 200 of this embodiment includes receiving a module characteristic from a system environment, wherein the system environment comprises one or more modules, and wherein the module characteristic comprises module dependencies, module certifications, and module versions. As used herein, a module may include an application, software, hardware, components, and/or the like. In some embodiments, a module may include a system, a sub-system, a microsystem, a service, a microservice, semi-contained applications, fully contained applications, and/or the like. In this way, the module may describe any portion of a system that performs a function. For instance, the module may include specific applications that perform certain processes, such as information technology service management, service requests, incident management, log analysis, log troubleshooting, security, centralized communication platforms, human resource management, and/or the like.

In some embodiments, the module characteristic may include information relating to how the module operates within the system environment. In some embodiments, this may include information associated with the module relating to the module's dependencies, certifications, versions, and/or the like.

As used herein, dependencies may include module dependencies with one or more additional modules. In some embodiments, a dependency may include an interdependency. In some embodiments, the interdependency may include a first module being dependent (e.g., interdependent) on a second module. In this way, the first module's functionality may depend on the second module's functionality. For instance, if the first module requires a specific piece of information produced by the second module, the first module may be dependent on the second module. In some embodiments, the dependency may be reciprocal between the modules (e.g., the one or more modules are dependent on each other), or the dependency may flow in one direction. In this way, the module characteristic may describe the relationship the module has with the one or more additional modules in the system.

In some embodiments, the dependencies may include upstream dependencies, downstream dependencies, or the like. As used herein, an upstream dependency may refer to the ordering of a particular process carried out by a module within a system environment that comprises one or more modules. In some embodiments, an upstream module may include a first module that produces a result that is later used by a second module. For instance, if a first module produces a particular result, and that particular result is then later used by a second module, the first module may be upstream from the second module. In some embodiments, modules may have upstream dependencies on one or more additional modules.

As used herein, a downstream dependency may refer to the ordering of a particular process carried out by a module within a system environment that comprises one or more modules. In some embodiments, a downstream module may include a first module that receives a result earlier produced by a second module. For instance, if a first module uses a particular result, where that particular result was earlier produced by a second module, the first module may be downstream from the second module.

In some embodiments, the dependencies may further include logical dependencies, preferential dependencies, resource dependencies, external dependencies, task dependencies, critical path dependencies, and/or the like. In this way, the module interdependency determination system may describe the dependency by its type and how the system may respond to the dependency. For instance, if a module has an upstream dependency, and that dependency is a critical path, the module may require information from another module before the system can function properly. In this way, the module interdependency determination system may place a heavy emphasis (e.g., weight) on ensuring the module's characteristics are up to date.

In some embodiments, the module certifications may include a certification, re-certification, outdated certification, upcoming certification, and/or the like, associated with the module. In some embodiments, certain modules may require a certification to function as expected. In some embodiments, these certifications may be associated with internal certification departments, external certification entities, regulatory certifying agencies, and/or the like. In this way, the certifications associated with a particular module may be required to be updated from time to time. In some embodiments, within the system environment, a first module, and any dependent modules, may require the first module to be certified before a process can be performed. In this way, the module interdependency determination system may recognize an outdated certification, for example, and cause that module's certification to be updated.

Similarly, in some embodiments, a module may be required to be updated to a new version. In some embodiments, recording the new version associated with the module may be a requisite step in completing a particular process. In some embodiments, if the module interdependency determination detects a module's version is out of date, the module interdependency determination system may update that module's version to the correct version.

In some embodiments, receiving the module characteristic includes receiving the module characteristic associated with the one or more modules of the system environment. In some embodiments, the module interdependency determination system may receive module characteristics from all the modules in the system environment. In this way, the module interdependency determination system may know the overall module interdependencies. Additionally, or alternatively, the module interdependency determination system may isolate a particular module and its string of interdependencies. In this way, the module interdependency determination system may view the interdependencies within they system to analyze how one module effects the functionality of the system as a whole.

As shown in block 204, the process flow 200 of this embodiment includes mapping the module characteristic, wherein mapping the module characteristic comprises comparing the module characteristic associated with the module with the module characteristic associated with the system environment. In some embodiments, the module may store information associated with the module, such as the module characteristic. In this way, the module itself may keep track of the module dependencies, module certifications, module versions, and/or the like. In some embodiments, the system environment may also store the module characteristic associated with the module. In this way, the module interdependency determination system comparing the module characteristics may show differences between the module characteristics within the system environment and the module.

As shown in block 206, the process flow 200 of this embodiment includes determining a weight for the one or more modules, wherein determining the weight comprises evaluating a significance level of the information produced by the modules, analyzing a number of active modules contributing to a process, computing a weight value, and prioritizing the modules based on the weight value.

As used herein, a process may include a process within the system environment that one or more modules are associated with. In this way, the process may include a dependency relationship of one or more modules. In some embodiments, a module may be associated with one or more processes.

In some embodiments, determining the weight for the one or more modules may include aggregating the module characteristics associated with the one or more modules. In some embodiments, determining the weight may include aggregating other information associated with the system environment, modules, additional modules, and/or the like.

In some embodiments, the significance level of information produced by the modules may include analyzing the information produced by the modules. In some embodiments, the differences in information produced by the modules may alter the significance level of the module. For instance, if a module is producing highly sensitive information associated with an entity that is hosting the module interdependency determination system, that module may have a high significance level. In some embodiments, the significance level may be associated with the type of information produced, the process the module is associated with, and/or the like.

In some embodiments, analyzing the number of active modules contributing to a process may include determining the number of modules associated with a particular process. In some embodiments, the process may be a specific process, such as handling a request associated with an information technology service. In some embodiments, the process may be a general process, such as managing an entity's file sharing network. In some embodiments, the number of modules associated with a process may indicate how the module interdependency determination system should prioritize the modules associated with the process. For instance, if there are a high number of modules associated with a process, the process may have a high priority.

In some embodiments, computing a weight value may include an accounting of the significance level of information produced by a module and how many other modules are associated with the module in a process. In some embodiments, the weight value may also include a frequency of use of the module, a versatility value of the module, whether the module produces redundant information, and/or the like. In some embodiments, the frequency of use of the module may include how often the module is used in general or in a particular process. In some embodiments, the versatility value may include how many processes the module is associated with. In some embodiments, determining whether the module produces redundant information may include determining whether the module produces information another module also produces.

In some embodiments, the module interdependency determination system may determine a priority of the modules within the system environment. In some embodiments, the priority may include prioritizing the implementation of the module update to conserve resources of the system. In this way, the module interdependency determination system may create a module update of a module that has a high priority value.

In some embodiments, the prioritization may include predicting whether a module may need a module update. In this way, the module interdependency determination system may analyze the processes a module is associated with. In some embodiments, the module may require a module update for some, but not all, of the processes the module is associated with. Further, the module interdependency determination system, via the weight value, may determine a module update is required given the amount of processes the module is associated with.

As shown in block 208, the process flow 200 of this embodiment includes determining, using an artificial intelligence module, a module update for the module characteristic, wherein the module update comprises updating the module dependencies, module certifications, and module versions. In some embodiments, the artificial intelligence module may use a variety of tools to update the module characteristics. In some embodiments, these tools may include natural language processing, sentiment analysis, semantic analysis, machine learning, and/or the like. In some embodiments, the module interdependency determination system, via the artificial intelligence module, may be able to create an update for the module in response to the information received in the form of the module characteristics. In some embodiments, the module interdependency determination system may notify a user of the system to prompt the user to create an update for a module.

In some embodiments, the module update may include an update to the module, the module characteristics, the additional modules, the system environment, and/or the like. In some embodiments, the module update may include an update to the module dependencies, module certifications, module versions, and/or the like. In some embodiments, updating the module dependencies, for example, may include determining any additional modules added to a dependency relationship, reconfiguring existing module dependencies within the dependency relationship, or removing module dependencies within the dependency relationship based on redundancies. In some embodiments, the dependency relationship may include one or more modules that are dependent on each other for a particular process. In this way, the module interdependency determination system may alter the dependency relationship via the module update.

As shown in block 210, the process flow 200 of this embodiment includes implementing the module update in the system environment. In some embodiments, implementing the module update in the system environment includes the artificial intelligence module implementing the module update. In some embodiments, the module interdependency determination system may automatically update the module (e.g., update the module characteristics). In some embodiments, the module interdependency determination system may notify a user of the system to update the module and its associated module characteristics.

In some embodiments, the present invention may create a module dependency interface, wherein the module dependency interface includes the module characteristics associated with the module and the dependency module map. In some embodiments, the present invention may transmit the module dependency interface to a user device, wherein transmitting the module dependency interface configures a graphical user interface of the user device.

In some embodiments, the module characteristic further comprises information relating to how the module interacts with the one or more additional modules and the system environment. In some embodiments, the interaction between the modules may include how a module receives information from other modules. For instance, if a first module may receive information for a particular process from a second module and a third module, the module interdependency determination system may also consider the system environment as a whole. In this way, the module interdependency determination system may create the module map, determine if a module update is required, and/or the like with regard to the system environment.

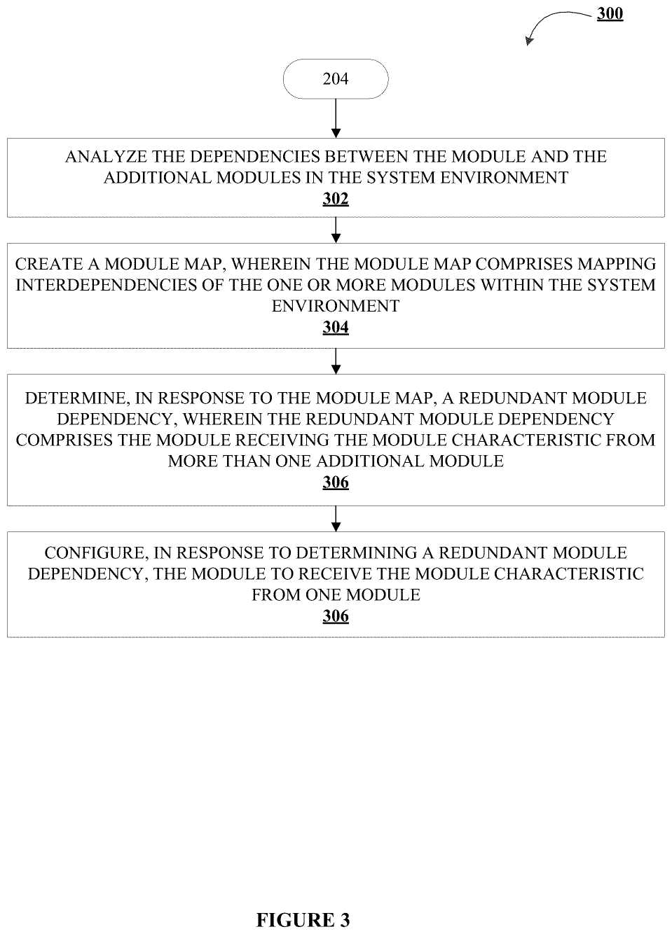

FIG. 3 illustrates a process flow for configuring a module to receive a module characteristic from one module, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a module interdependency determination system (e.g., similar to one or more of the systems described herein with respect to FIGS. 1A-1C) may perform one or more of the steps of process flow 300. For example, a module interdependency determination system (e.g., the system 130 described herein with respect to FIGS. 1A-1C) may perform the steps of process flow 300.

As shown in block 302, the process flow 300 of this embodiment includes analyzing the dependencies between the module and the additional modules in the system environment. In some embodiments, the artificial intelligence module may analyze the dependencies between the module and the additional modules in the system environment. In some embodiments, the analysis may include determining the type of dependencies between the modules. In some embodiments, the analysis may include determining a frequency of use of the dependency relationship between the modules.

As shown in block 304, the process flow 300 of this embodiment includes creating a module map, wherein the module map comprises mapping interdependencies of the one or more modules within the system environment. In some embodiments, the module map may include aggregating the dependencies of the modules within the system environment.

In some embodiments, the module interdependency determination system may determine, via the module map, a priority level for the modules and their associated dependencies. In this way, the module interdependency determination system may determine a high priority process in response to the module map and may classify the modules within that process to be high priority modules. In some embodiments, the high priority classification may include the module characteristics associated with those high priority modules. In some embodiments, determining the high priority modules may include weighting the module dependencies while considering the processes in which they are involved.

As shown in block 306, the process flow 300 of this embodiment includes determining, in response to the module map, a redundant module dependency, wherein the redundant module dependency comprises the module receiving the module characteristic from more than one additional module. In some embodiments, the redundant module dependency may include a module receiving the same information from more than one additional module. In this way, the module may receive duplicated information from another module in the system environment. For instance, if a first module receives information relating to a particular process from a second module, and the first module also receives the same information from a third module, the module interdependency determination system may determine a redundant module dependency exists.

In some embodiments, the module interdependency determination may determine a redundant module dependency exists based on resources consumed by the system to produce a particular result. In some embodiments, if the resources consumed exceed a certain level, the module interdependency determination system may determine a redundant module dependency exists. For instance, if the number of resources consumed by the system exceed an acceptable level, the module interdependency determination system may determine a redundancy exists within the system. In this way, the module interdependency determination system may know the minimum resources required to complete a particular process. If that minimum number of resources is exceeded due to, for example, an additional module being added to the system, more dependencies being created within the system, a module versioning up, or the like, the module interdependency determination system may determine a redundant module dependency exists.

As shown in block 308, the process flow 300 of this embodiment includes configuring, in response to determining a redundant module dependency, the module to receive the module characteristic from one module. In some embodiments, configuring may include reconfiguring the module that is determined to be associated with a redundant module dependency. In some embodiments, the module interdependency determination system may configure (e.g., reconfigure) the module to receive certain information from a single module. In this way, the module interdependency determination system may reconfigure how modules receive information in response to the efficiency of the system environment. In other words, the module interdependency determination system may reconfigure the modules to reduce the amount of redundant information being transmitted.

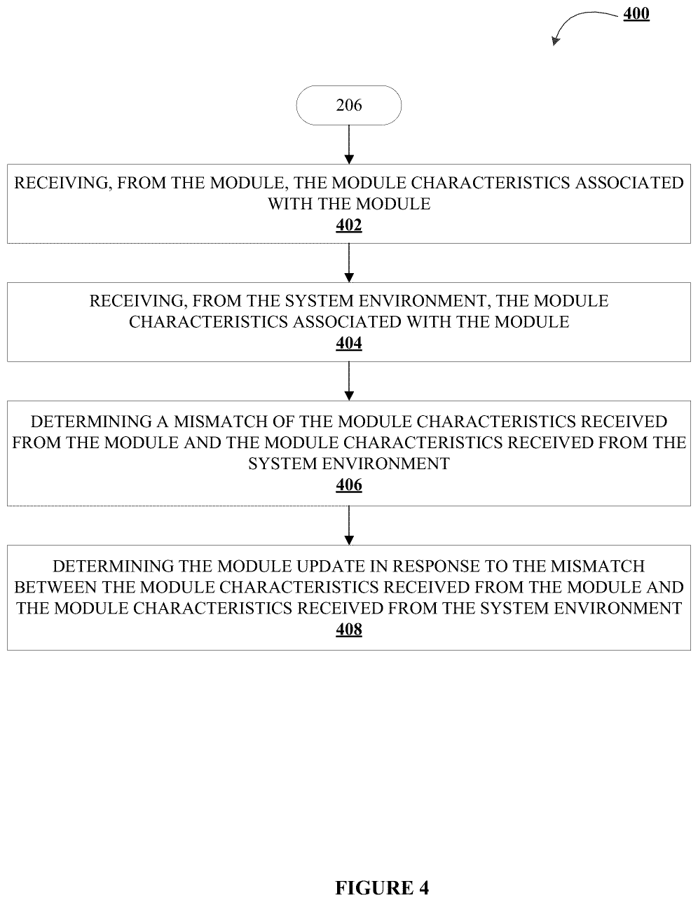

FIG. 4 illustrates a process flow for determining a module update in response to a mismatch between the module characteristics received from the module and the module characteristics received from a system environment, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a module interdependency determination system (e.g., similar to one or more of the systems described herein with respect to FIGS. 1A-1C) may perform one or more of the steps of process flow 400. For example, a module interdependency determination system (e.g., the system 130 described herein with respect to FIGS. 1A-1C) may perform the steps of process flow 400.

As shown in block 402, the process flow 400 of this embodiment includes receiving, from the module, the module characteristics associated with the module. In some embodiments, the module characteristics received from the module may include module dependencies, module certifications, module versions, and/or the like associated with the module. In this way, the module may store the module characteristics and transmit them to the module interdependency determination system. In some embodiments, the module dependencies stored within the module may relate to the module's view of the dependencies associated with the module. In some embodiments, the module certifications may include the certifications stored within the module. In some embodiments, the module versions may include the version the module is currently running.

As shown in block 404, the process flow 400 of this embodiment includes receiving, from the system environment, the module characteristics associated with the module. In some embodiments, the module characteristics received from the system environment may include the system's view on the module's characteristics. Similar to the module characteristics received from the module, the module characteristics received from the system environment may include module dependencies, module certifications, module versions, and/or the like. In this way, the system environment may store the module characteristics and transmit them to the module interdependency determination system.

As shown in block 406, the process flow 400 of this embodiment includes determining a mismatch of the module characteristics received from the module and the module characteristics received from the system environment. In some embodiments, the mismatch may include discrepancies between the module characteristics received from the module and the module characteristics received from the system environment. In some embodiments, the mismatch may include a mismatch in the module dependencies, module certifications, module versions, and/or the like. For instance, and by way of non-limiting example, if there is a discrepancy in the module dependencies, the module interdependency determination system may determine a mismatch exists. In this way, the module characteristics received from the module may show a first dependency relationship and the module characteristics received form the system environment may show a second dependency relationship, where the first and second dependency relationships are different. In this case, the module interdependency determination system may determine a mismatch relating to the module dependency.

As shown in block 408, the process flow 400 of this embodiment includes determining the module update in response to the mismatch between the module characteristics received from the module and the module characteristics received from the system environment. In some embodiments, determining the module update may configure (e.g., reconfigure) the module, the module characteristics, the additional modules, the system environment, and/or the like. In this way, the module update may adjust parameters associated with the module throughout the system. In an instance where the module update configures the module, the module characteristics may be reconfigured to correct mismatches associated with the module dependencies, module certifications, module versions, and/or the like. In another instance where the module update configures the system environment, for example, the module update may reconfigure the system environment to view the updated module dependencies, module certifications, module versions, and/or the like.

For example, a module characteristic received from a module may represent a first configuration of a module dependency. The module characteristic received from the system environment may represent a second configuration of the module dependency, where the first and second module dependencies are not the same. After the mismatch is determined, the module interdependency determination system may reconfigure, through a module update, the module, the additional modules in the dependency relationship, or the system environment to correct the mismatch.

In some embodiments, the module interdependency determination system may implement the module update autonomously. In some embodiments, the module interdependency determination system may notify a user, owner, technician, and/or the like, to implement the module update.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for determining module interdependency using advanced computational models for data analysis and automated processing, the system comprising:
a processing device;
a non-transitory storage device containing instructions when executed by the processing device, causes the processing device to perform the steps of:
receive a module characteristic from a system environment, wherein the system environment comprises one or more modules, and wherein the module characteristic comprises module dependencies, module certifications, and module versions;
map the module characteristic, wherein mapping the module characteristic comprises comparing the module characteristic associated with the module with the module characteristic associated with the system environment;
determine a weight for the one or more modules, wherein determining the weight comprises evaluating a significance level of the information produced by the modules, analyzing a number of active modules contributing to a process, computing a weight value, and prioritizing the modules based on the weight value;
determine, using an artificial intelligence module, a module update for the module characteristic, wherein the module update comprises updating the module dependencies, module certifications, and module versions; and
implement the module update in the system environment.

2. The system of claim 1, wherein receiving the module characteristic comprises receiving the module characteristic associated with the one or more modules of the system environment.

3. The system of claim 1, wherein mapping the module characteristic comprises:
analyzing the dependencies between the module and the additional modules in the system environment; and
creating a module map, wherein the module map comprises mapping interdependencies of the one or more modules within the system environment.

4. The system of claim 3, wherein executing the instructions further causes the processing device to:
determine, in response to the module map, a redundant module dependency, wherein the redundant module dependency comprises the module receiving the module characteristic from more than one additional module; and
configure, in response to determining a redundant module dependency, the module to receive the module characteristic from one module.

5. The system of claim 1, wherein determining the module update further comprises:
receiving, from the module, the module characteristics associated with the module;
receiving, from the system environment, the module characteristics associated with the module;
determining a mismatch of the module characteristics received from the module and the module characteristics received from the system environment; and
determining the module update in response to the mismatch between the module characteristics received from the module and the module characteristics received from the system environment.

6. The system of claim 1, wherein implementing the module update in the system environment comprises the artificial intelligence module implementing the module update.

7. The system of claim 1, wherein executing the instructions further causes the processing device to:
create a module dependency interface, wherein the module dependency interface comprises the module characteristics associated with the module and the dependency module map; and
transmit the module dependency interface to a user device, wherein transmitting the module dependency interface configures a graphical user interface of the user device.

8. The system of claim 1, wherein the module characteristic further comprises information relating to how the module interacts with the one or more additional modules and the system environment.

9. A computer program product for determining module interdependency using advanced computational models for data analysis and automated processing, the computer program product comprising a non-transitory computer-readable medium comprising code causing an apparatus to:
receive a module characteristic from a system environment, wherein the system environment comprises one or more modules, and wherein the module characteristic comprises module dependencies, module certifications, and module versions;
map the module characteristic, wherein mapping the module characteristic comprises comparing the module characteristic associated with the module with the module characteristic associated with the system environment;
determine a weight for the one or more modules, wherein determining the weight comprises evaluating a significance level of the information produced by the modules, analyzing a number of active modules contributing to a process, computing a weight value, and prioritizing the modules based on the weight value;
determine, using an artificial intelligence module, a module update for the module characteristic, wherein the module update comprises updating the module dependencies, module certifications, and module versions; and
implement the module update in the system environment.

10. The computer program product of claim 1, wherein receiving the module characteristic comprises receiving the module characteristic associated with the one or more modules of the system environment.

11. The computer program product of claim 1, wherein mapping the module characteristic comprises:
analyzing the dependencies between the module and the additional modules in the system environment; and
creating a module map, wherein the module map comprises mapping interdependencies of the one or more modules within the system environment.

12. The computer program product of claim 11, wherein the code further causes the apparatus to:
determine, in response to the module map, a redundant module dependency, wherein the redundant module dependency comprises the module receiving the module characteristic from more than one additional module; and
configure, in response to determining a redundant module dependency, the module to receive the module characteristic from one module.

13. The computer program product of claim 1, wherein determining the module update further comprises:
receiving, from the module, the module characteristics associated with the module;
receiving, from the system environment, the module characteristics associated with the module;
determining a mismatch of the module characteristics received from the module and the module characteristics received from the system environment; and
determining the module update in response to the mismatch between the module characteristics received from the module and the module characteristics received from the system environment.

14. The computer program product of claim 1, wherein implementing the module update in the system environment comprises the artificial intelligence module implementing the module update.

15. The computer program product of claim 1, wherein the code further causes the apparatus to:
create a module dependency interface, wherein the module dependency interface comprises the module characteristics associated with the module and the dependency module map; and
transmit the module dependency interface to a user device, wherein transmitting the module dependency interface configures a graphical user interface of the user device.

16. The computer program product of claim 1, wherein the module characteristic further comprises information relating to how the module interacts with the one or more additional modules and the system environment.

17. A method for determining module interdependency using advanced computational models for data analysis and automated processing, the method comprising:
receiving a module characteristic from a system environment, wherein the system environment comprises one or more modules, and wherein the module characteristic comprises module dependencies, module certifications, and module versions;
mapping the module characteristic, wherein mapping the module characteristic comprises comparing the module characteristic associated with the module with the module characteristic associated with the system environment;
determining a weight for the one or more modules, wherein determining the weight comprises evaluating a significance level of the information produced by the modules, analyzing a number of active modules contributing to a process, computing a weight value, and prioritizing the modules based on the weight value;
determining, using an artificial intelligence module, a module update for the module characteristic, wherein the module update comprises updating the module dependencies, module certifications, and module versions; and
implementing the module update in the system environment.

18. The method of claim 17, wherein receiving the module characteristic comprises receiving the module characteristic associated with the one or more modules of the system environment.

19. The method of claim 17, wherein mapping the module characteristic comprises:
analyzing the dependencies between the module and the additional modules in the system environment; and
creating a module map, wherein the module map comprises mapping interdependencies of the one or more modules within the system environment.

20. The method of claim 17, wherein the method further comprises:
determining, in response to the module map, a redundant module dependency, wherein the redundant module dependency comprises the module receiving the module characteristic from more than one additional module; and
configuring, in response to determining a redundant module dependency, the module to receive the module characteristic from one module.
